(19) United States
(12) Patent Application Publication
(10) Pub. No.: US 2012/0106123 A1
(43) Pub. Date: May 3, 2012

(54) ILLUMINATION DEVICE COMPRISING AN INTERNAL POWER SOURCE AND AN INTERFACE FOR CONNECTING THE ILLUMINATION DEVICE TO AN EXTERNAL POWER SUPPLY

(75) Inventor: Theodoor Cornelis Treurniet, Best (NL)

(73) Assignee: KONINKLIJKE PHILIPS ELECTRONICS N.V., EINDHOVEN (NL)

(21) Appl. No.: 13/379,039

(22) PCT Filed: Jun. 11, 2010
(86) PCT No.: PCT/IB2010/052612

§ 371 Date: Dec. 19, 2011

(30) Foreign Application Priority Data
Jun. 17, 2009 (EP) 09162943.6

(51) Int. Cl. F21L 4/00

(52) U.S. Cl. 362/20

(57) ABSTRACT

An illumination device comprising: at least one light emitting device (106); an internal power source (208); an electrical interface (112) for electrically connecting said illumination device to an external power supply (210); a thermal interface (114) for thermally connecting said illumination device to an external heat sink (121); and a circuitry for operating said illumination device in a first mode when disconnected from at least one of said external power supply (210) and said external heat sink (121), in which first mode said at least one light emitting device (106) is powered by said internal power source (208), and in a second mode when said illumination device is connected to said external power supply (210) and said external heat sink (121), in which second mode said at least one light emitting device (106) is powered by said external power supply (210), and wherein a first maximum luminance in said first mode is restricted relative a second maximum luminance in said second mode.

### TECHNICAL FIELD

The present invention relates to an illumination device comprising an internal power source and an electrical interface for electrically connecting the illumination device to an external power supply. It also relates to an interfacing device that provides an external power supply, and to a system comprising such an illumination device and such an interfacing device.

### BACKGROUND OF THE INVENTION

A movable lamp may be convenient in situations where there are no luminaires available or where the illumination from the available luminaires is insufficient.

If the movable lamp is used where there is no electricity available from the mains supply, the movable lamp must be powered by an internal power source, such as a battery. However, due to the limited power available from a battery, it is often preferred to power the movable lamp via the mains supply when possible.

A prior art arrangement that can be used in both situations would be an illumination system comprising a battery-powered lamp and a charger that can be connected to the mains supply. Thus, when electricity is available through the mains supply, the lamp can be connected to the charger and receive power from the mains supply, whereas the movable lamp may also be disconnected from the charger and be used to illuminate areas where there is no electricity available.

However, there still seems to be room to provide an improved illumination device.

### SUMMARY OF THE INVENTION

In view of the above, an object of the invention is to provide an improved illumination device.

According to an aspect of the invention, there is provided an illumination device comprising at least one light emitting device; an internal power source; an electrical interface for electrically connecting the illumination device to an external power supply; a thermal interface for thermally connecting the illumination device to an external heat sink; and a circuitry for operating the illumination device in a first mode when disconnected from at least one of the external power supply and the external heat sink, in which first mode the at least one light emitting device is powered by the internal power source, and in a second mode when the illumination device is connected to the external power supply and the external heat sink, in which second mode the at least one light emitting device is powered by the external power supply, and wherein a maximum luminance of the illumination device in said first mode is restricted relative a maximum luminance of the illumination device in said second mode.

The present invention is based on the understanding that by providing an illumination device that operates in a first mode when disconnected from the external power supply and in a second mode when connected to the external power supply, and designing the maximum luminance for each mode separately, the performance of the illumination can be improved. This is because, the maximum luminance when the illumination device is powered by the internal power source, primarily is limited by the capacity of the internal power source, whereas the maximum luminance when the illumination device is powered via an external power supply, such as the mains supply, rather is limited by the heat developed in the illumination device. Thus, by providing an illumination device operable in a first and second mode, and designing the maximum luminance for each mode separately, the illumination device can fully exploit the available capacity in both situations. Moreover, by providing an external heat sink it is possible to further increase the maximum luminance when the illumination device is connected to the external power supply, while keeping the size and weight of the illumination device down.

According to an embodiment a selector may be arranged to switch between the first mode and the second mode. The selector may be automatically operable, for example, by means of a control unit that detects when the illumination device is connected to the external power supply and the external heat sink and in response thereto changes to the second mode.

The circuitry may be configured in such a way that the at least one light emitting device is operated at a higher power when the illumination device is operated in the second mode than when the illumination device is operated in the first mode.

Furthermore, for an illumination device comprising a plurality of light emitting devices, the circuitry may be configured in such a way that more light emitting devices are activated when the illumination device is operated in the second mode than when the illumination device is operated in the first mode.

The circuitry may also be configured to enable charging of the internal power source when the illumination device is electrically connected to the external power supply. An advantage associated herewith is that the internal power source can be charged without being removed from the illumination device.

According to an embodiment, the electrical interface may be configured to transfer electrical energy via direct electrical contact, thereby providing an efficient and reliable way to transfer electricity between the external power supply and the illumination device.

Furthermore, the electrical interface and the thermal interface may be arranged in a plug adapted to be received in a corresponding socket in an interfacing device. As the electrical interface and the thermal interface are both integrated in the plug it can be ensured that when the illumination device is connected to the external power supply it will also be connected to the external heat sink, and thus overheating may efficiently be prevented.

According to another aspect of the invention, there is provided an interfacing device comprising: a power supply; a heat sink; an electrical interface for electrically connecting the power supply to an illumination device adapted to operate in a first mode when disconnected from the interfacing device and a second mode when connected to the interfacing device, wherein a first maximum luminance in the first mode is restricted relative a second maximum luminance in the second mode; and a thermal interface for thermally connecting the heat sink to the illumination device. Thus, as the illumination device is connected to the interfacing device, the interfacing device may power the illumination device and provide enhanced heat dissipation from the illumination device to an ambient environment via the heat sink.

The electrical interface and the thermal interface may be provided in a socket adapted to receive a corresponding plug of the illumination device. As the electrical interface and the thermal interface are both integrated in the socket it can be ensured sure that when the illumination device is connected to the external power supply it will also be connected to the external heat sink, and thus overheating may efficiently be prevented.

The power supply may preferably be adapted to receive its electrical energy from a mains supply, for example, by connecting the interfacing device to a wall socket.

Furthermore, the illumination device according to the present invention may advantageously be included in an illumination system, further comprising an interfacing device comprising: a power supply; a heat sink; an electrical interface for electrically connecting the power supply to the illumination device; and a thermal interface for thermally connecting the heat sink to the illumination device.

Other objectives, features and advantages will appear from the following detailed disclosure, from the attached dependent claims as well as from the drawings.

### BRIEF DESCRIPTION OF THE DRAWINGS

The above, as well as additional objects, features and advantages of the present invention, will be better understood through the following illustrative and non-limiting detailed description of preferred embodiments of the present invention, with reference to the appended drawings, where the same reference numerals will be used for similar elements, wherein:

FIG. 1 schematically illustrates an illumination system according to an embodiment of the invention.

FIG. 2 schematically illustrates a circuitry of the illumination device according to an embodiment of the invention.

### DETAILED DESCRIPTION OF PREFERRED EMBODIMENTS

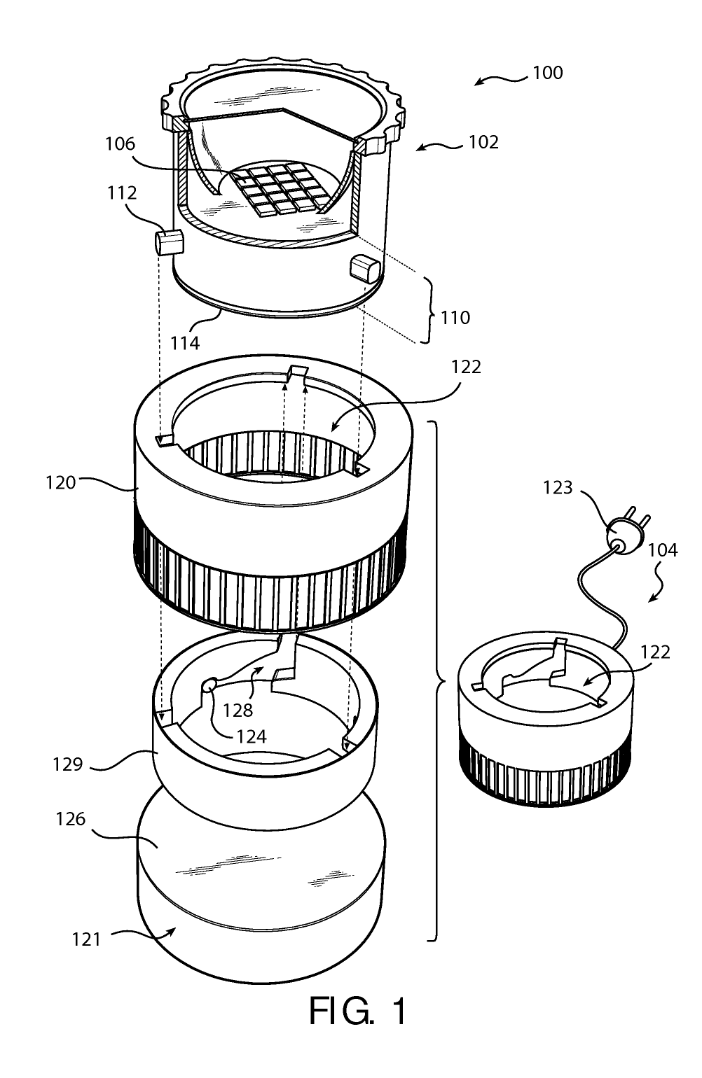

FIG. 1 schematically illustrates an illumination system according to an embodiment of the invention. The illumination system 100 comprises an illumination device 102, and an interfacing device 104, here being a charger.

The illumination device is here a movable lamp dimensioned such that a user can pick-up the illumination device and place it at a desired location. Thus, a user may e.g. take the illumination device out of the charger and place it at a table next to his chair as a reading lamp. The illustrated illumination device has a diameter about 80 mm and height about 60 mm. However, as is recognized by a person skilled in the art the size of the illumination device may vary.

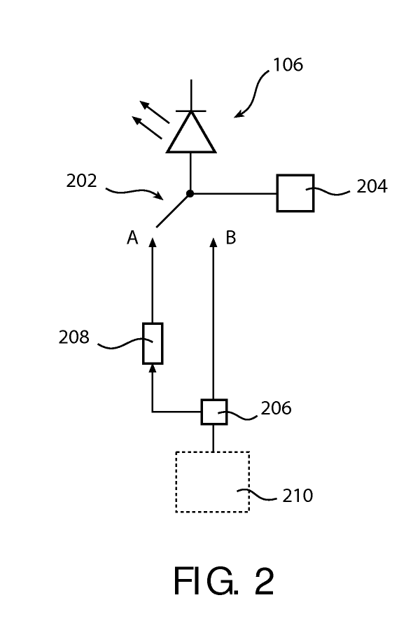

The illumination device 102 comprises a plurality light emitting devices 106, here being light emitting diodes (LEDs) 106 arranged on a printed circuit board. The number of LEDs will vary depending on the application, but is typically selected based on the amount of heat that can be dissipated from the illumination device when it is connected to an external heat sink provided in the charger. Here, there are twenty high power LEDs, each having a power of about 1 W. There is also an internal power source 208 (illustrated in FIG. 2) in the form of one or more re-chargeable batteries (e.g. Ni—Cd cells) arranged in the illumination device to power the LEDs 106. However, other means of storing electrical energy, such as super capacitors, can also be used.

In the illustrated example, the lower portion of the illumination device forms a plug 110 that enables the illumination device 102 to be connected to a corresponding socket 122 in the charger 104. The plug 110 has an electrical interface 112 for electrically connecting the illumination device to an external power supply 210 provided in the charger, and a thermal interface 114 for thermally connecting the illumination device to a heat sink 121 in the charger. The electrical interface is here in the form of three electrical contact pins 112 protruding radially from the side of the illumination device. The electrical contact pins can be made of copper or other electrically conducting material. Also, each electrical contact pin is electrically connected to the printed circuit board and thus to the LEDs 106 arranged thereon.

The thermal interface 114 is here a flat copper plate that forms the bottom surface of the illumination device. Other materials having a high thermal conductivity such as carbon, an aluminium alloy, thermally conductive plastic or ceramics may also be used for the thermal interface. The flat copper plate is in thermal contact with the LEDs, e.g. by means of a series of thermal vias provided in the printed circuit board. The area of the thermal interface 114 is designed to enable sufficient heat to be dissipated from the illumination device to the external heat sink 121 in the charger. In the illustrated example, the thermal interface constitutes essentially the entire bottom surface of the illumination device.

The charger 104 illustrated in FIG. 1, comprises a plastic housing 120, a heat sink 121 (typically made in aluminium), and a main plug 123 for connecting the charger to a mains supply. A socket 122 provided in the charger is adapted to receive the plug 110 of the illumination device. The thermal interface 126 of the charger is here the flat upper surface of the heat sink 121 which is accessible through the socket 122. Further, the socket 122 comprises a plastic ring 129 provided with three L-shaped recesses 128, adapted to receive the electrical contact pins 112 of the illumination device. An electrical interface 124 in the charger is here provided by means of three contact plates 124 arranged in the plastic ring 129. The contact plates 124 are made in copper, or some other electrically conductive material, and are electrically connected to the main plug 123. The illumination device can thus be connected to the charger, by introducing the electrical contact pins 112 into the L-shaped recesses 128, and pressing down the illumination device while turning it anti-clockwise. Through this arrangement, each electrical contact pin 112 will not only be in electrical contact with its corresponding contact plate 124 in the charger, but the electrical contact pins will also mechanically connect the illumination device 102 to the charger 104, and press the thermal interface 114 of the illumination device against the upper surface of the heat sink 126 thereby enabling enhanced heat transfer.

FIG. 2 schematically illustrates a circuitry of the illumination device. The LEDs 106 are here connected to a selector 202 arranged to switch between a first position A, where the LEDs are powered via the internal power source 208, and a second position B, where the LEDs 106 are powered via the external power supply 210 (which is here the mains supply provided via the charger 104). A control unit 204, e.g. a central processing unit (CPU), is here arranged to automatically control the selector. However, the selector may also be operated by means of a mechanical switch that is pressed in as the illumination device is arranged in the charger. There is also a voltage converter 206 for converting the electricity from the mains supply to a voltage that is safe to use for the illumination device. The circuitry also enables the internal power source 208 to be charged via the mains supply when the illumination device 102 is connected to the charger 104. Although all driving electronics is here arranged in the illumination device, it is also possible to provide a first driving circuit, for powering the LEDs via the internal power source, in the illumination device 102, and a second driving circuit, for powering the LEDs via the external power supply, in the charger 104.

The illumination device 102 can be operated in a first mode having a first maximum luminance when disconnected from the charger 104 and in a second mode having a second maximum luminance when the illumination device is connected to the charger 104. The first luminance is here restricted relative the second luminance, primarily due to the limited capacity of the internal power source. The restricted maximum luminance can be achieved by operating the LEDs at lower power and/or by only activating a subset of LEDs when the illumination device is disconnected from the charger.

In operation, when the illumination device 102 is switched on by a user, the control unit 204 determines whether the illumination device is connected to the charger or not. This can be done by detecting whether there is a voltage applied to the electrical contact pins 112 of the illumination device. However, it can also be detected by a mechanical switch that is pressed in as the illumination device is arranged in the charger.

If there is no voltage applied to the electrical contact pins, this means that the illumination device 102 is disconnected from the charger 104, and thus the control unit 204 sets the selector 202 in position A. Consequently, the LEDs 202 are powered by the internal power source 208, and the illumination device is operated in the first mode having a first maximum luminance.

If, on the other hand, the control unit detects a voltage applied to the electrical contact pins 112, this means that the illumination device 102 is connected to the charger 104, and thus the control unit 204 sets the selector 202 in position B. Consequently, the LEDs 106 are powered via the mains supply, and the illumination device is operated in a second mode having a second maximum luminance. Furthermore, as the illumination device 102 in this case is connected to the external heat sink 121 provided in the charger 104, the heat developed at the LED junctions will be transferred from the illumination device to the heat sink 121 in the charger via the thermal interfaces 114,126. Thus, the heat developed by the illumination device can be dissipated to the ambient environment via the heat sink 121.

The first maximum luminance is typically designed based on the capacity of the internal power source 208, as this is normally the primary limitation when the illumination device is disconnected from the charger. In a typical consumer application the power available to the illumination device is typically limited to about 5 W to have a reasonable battery life. Thus, the control unit may restrict the first maximum luminance by operating all of the twenty LEDs with a maximum power of 0.25 W per LED. Alternatively, the control unit may activate five of the twenty LEDs at full power (i.e. 1 W per LED).

Since the total number of LEDs in the illumination device typically has been selected based on the conditions when the illumination device is connected to the charger, there is no need for any restriction for the second maximum luminance, and thus all of the twenty high power LEDs can be operated at full power (i.e. 1 W).

The invention has mainly been described above with reference to a few embodiments. However, as is readily appreciated by a person skilled in the art, other embodiments than the ones disclosed above are equally possible within the scope of the invention, as defined by the appended claims. For example, although the external power supply and the external heat sink have been described as part of a charger, the external power supply and the external heat sink may be provided separately. Furthermore, the design of the plug of the illumination device and socket in the charger may vary. For example, there may be two electrical contact pins protruding from the bottom surface of the illumination device, which can be inserted into two holes provided at the bottom of the socket similar to how a plug is inserted in a wall socket. Also, the thermal interface is not limited to a flat surface, but may have other shapes, as long as the shape of the thermal interface of the illumination device is complementary to the shape of the thermal interface of the charger to enable contact between the interfaces. It may also be possible to utilize a thermal interface material arranged between the thermal interface of the illumination device and the thermal interface of the charger to further enhance heat transfer from the illumination device to the heat sink. Furthermore, although the electrical interface has here been based on direct electrical contact, it is also possible to utilize an electrical interface that transfers electrical energy via induction. It is also possible to arrange an additional heat sink in the illumination device, in the event that the first maximum luminance would be restricted by the heat developed by the LEDs rather than by the capacity of the internal power source.

1. An illumination device comprising:
at least one light emitting device;
an internal power source;
an electrical interface for electrically connecting said illumination device to an external power supply;
a thermal interface for thermally connecting said illumination device to an external heat sink; and
a circuitry for operating said illumination device in a first mode when disconnected from at least one of said external power supply and said external heat sink, in which first mode said at least one light emitting device is powered by said internal power source, and in a second mode when said illumination device is connected to said external power supply and said external heat sink, in which second mode said at least one light emitting device is powered by said external power supply, and wherein a maximum luminance of said illumination device in said first mode is restricted relative a maximum luminance of said illumination device in said second mode.

2. An illumination device according to claim 1, wherein a selector is arranged to switch between said first mode and said second mode.

3. An illumination device according to claim 1, wherein the circuitry is configured in such a way that said at least one light emitting device is operated at a higher power when said illumination device is operated in said second mode than when said illumination device is operated in said first mode.

4. An illumination device according to claim 1, comprising a plurality of light emitting devices, wherein said circuitry is configured in such a way that more light emitting devices are activated when said illumination device is operated in said second mode than when said illumination device is operated in said first mode.

5. An illumination device according to claim 1, wherein said circuitry is configured to enable charging of said internal power source when said illumination device is electrically connected to said external power supply.

6. An illumination device according to claim 1, wherein the electrical interface is configured to transfer electrical energy via direct electrical contact.

7. An illumination device according to claim 1, wherein said electrical interface and said thermal interface are provided in a plug.

8. An interfacing device comprising:
a power supply;
a heat sink;
an electrical interface for electrically connecting said power supply to an illumination device adapted to operate in a first mode when disconnected from said interfacing device and a second mode when connected to said interfacing device, wherein a first maximum luminance in said first mode is restricted relative a second maximum luminance in said second mode; and
a thermal interface for thermally connecting said heat sink to said illumination device.

9. An interfacing device according to claim 8, wherein said electrical interface and said thermal interface are provided in a socket.

10. An interfacing device according to claim 8, wherein said power supply is adapted to receive its electrical energy from a mains supply.

11. An illumination system (100) comprising an illumination device according to claim 1, and an interfacing device, comprising
a power supply;
a heat sink;
an electrical interface for electrically connecting said power supply to said illumination device adapted to operate in a first mode when disconnected from said interfacing device and a second mode when connected to said interfacing device, wherein a first maximum luminance in said first mode is restricted relative a second maximum luminance in said second mode; and
a thermal interface for thermally connecting said heat sink to said illumination device.
